(19) United States
(12) Patent Application Publication
(10) Pub. No.: US 2001/0013864 A1
(43) Pub. Date: Aug. 16, 2001

(54) DRIVING VOLTAGE GENERATOR OF LIQUID CRYSTAL DISPLAY UNIT

(76) Inventors: RYOHEI KAKUTA, FUKUSHIMA-KEN (JP); HIDEAKI NAGAKUBO, FUKUSHIMA-KEN (JP); SEIJI TOKITA, FUKUSHIMA-KEN (JP); MITSUAKI YAMAZAKI, FUKUSHIMA-KEN (JP)

Correspondence Address: BRINKS HOFER GILSON & LIONE, P.O. BOX 10395, CHICAGO, IL, 60610, US

(21) Appl. No.: 09/112,715

(22) Filed: Jul. 9, 1998

(30) Foreign Application Priority Data
Jul. 9, 1997 (JP) 9-184190

(51) Int. Cl. G09G 5/00

(52) U.S. Cl. 345/211

(57) ABSTRACT

There is provided a small size and low price driving voltage generator (of a liquid crystal display unit) which can easily adjust output voltages. In this driving voltage generator, a DC-DC converter raises an input voltage (5 [V]) and produces voltages VH and VL. Resistors divide a voltage difference between the voltages VH and VL with resistors. Operational amplifiers output through current amplification each voltage divided by resistance. In the present invention, the external size can be reduced because only two output terminals are required for the DC-DC converter. In addition, manufacturing cost can be lowered because only two output terminals are required for the DC-DC converter. Moreover, since the resistors R1 to R6 are provided in the outside of the DC-DC converter (hybrid IC), these resistors can be exchanged easily. Therefore, the voltages V HCOM, V HSEG, V M, V LSEG, V LCOM can be adjusted easily.

### BACKGROUND OF THE INVENTION

1. Field of the Invention

The present invention relates to a driving voltage generator for supplying a driving voltage to a simple matrix type liquid crystal display unit.

Here, the driving voltage is particularly a driving voltage generated by ASDM (Advanced STN Driving Method).

2. Description of the Related Art

As a driving system of a simple matrix type liquid crystal display unit, “ASDM” and “Voltage Averaging Driving Method” are known.

Of the two methods, the ASDM is a method for driving a liquid crystal display unit utilizing five kinds of voltage (V HCOM, V HSEG, V M, V LSEG, and V LCOM).

Meanwhile, the voltage averaging driving method is a method for driving a liquid crystal display unit utilizing six kinds of voltage which are quite different from above five kinds of voltage.

As explained above, the voltages (number of kinds, potential) required for driving in both methods are different from each other.

Moreover, in both methods, waveforms (waveform patterns) of voltages to be impressed to common electrode and segment electrode are also different from each other (however, voltage waveform to be impressed finally to each liquid crystal cell is the same in both methods).

As explained above, both driving methods are quite different in the technical point of view.

Development history of both methods will be explained briefly hereunder.

In comparison of both driving methods, ASDM has been developed preceding the voltage averaging driving method.

However, ASDM is accompanied by a problem that the voltage impressed to the segment electrode is only a low voltage (5 to 6 [V]) but a higher voltage (about 60 [V]) is required as the voltage to be impressed to the common electrode.

With the technology of liquid crystal display unit in the earlier stage of development thereof, it has been difficult to produce a driver IC having a higher dielectric resistance.

The voltage averaging driving method has been proposed to solve the problem explained above of ASDM.

In the voltage averaging driving method, the waveform (waveform pattern) of the voltage to be impressed to each electrode is rather complicated than that in the ASDM by averaging the voltages to be impressed to the common electrode and segment electrode, but the voltage of each electrode can be controlled to about 30 [V].

Therefore, it is now possible to form the driver of each electrode into an IC by introducing the voltage averaging driving method.

However, recently, since the driver IC of the high dielectric resistance process has been developed, ASDM is drawing renewed attention because waveform of impressed voltage (waveform pattern) is more simplified.

It should be noted here that the present invention discloses a driving voltage generator to supply the driving voltage by ASDM.

Characteristics of ASDM will be explained below.

FIG. 3 is a diagram for explaining an example of the voltage used for driving a liquid crystal display unit by ASDM.

As shown in this figure, a liquid crystal display unit is driven by ASDM using five kinds of voltages: V HCOM, V HSEG, V M, V LSEG, and V LCOM. Here, V M is the reference voltage commonly used in the common side and segment side.

In this voltage format, when a certain common electrode is selected, the voltage (V HCOM - V M) or (V M - V LCOM) is impressed to the common electrode.

Meanwhile, when a certain segment electrode is selected, the voltage (V HSEG - V M) or (V M - V LSEG) is impressed to the segment electrode.

FIG. 4 is a block diagram showing a structure example of a driving voltage generator to produce each voltage shown in FIG. 3.

In this figure, a DC-DC converter 100 is a hybrid IC formed of a voltage boosting circuit composed of a switching IC and a transformer, etc.

The DC-DC converter 100 raises an input voltage (4 [V] as an example) to produce the voltages V HCOM, V HSET, V M, V LSEG, and V LCOM.

However, a driving voltage generator (for liquid crystal display unit) of the related art has been accompanied by the following problems.

\hat{1} Five output terminals are required for the DC-DC converter, resulting in increase of external size.

\hat{2} Five output terminals are required for the DC-DC converter resulting in rise of manufacturing cost.

\hat{3} The DC-DC converter uses a hybrid IC. Therefore, once it is manufactured, it is difficult to adjust the internal circuits and freely set the voltages V HCOM, V HSEG, V M, V, LSEG and V LCOM.

### OBJECT AND SUMMARY OF THE INVENTION

The present invention has been proposed against the background explained above and it is therefore an object of the present invention to provide a small size and low price driving voltage generator (for a liquid crystal display unit) which can easily adjust an output voltage.

The present invention is characterized in comprising a voltage producing means for producing two kinds of voltage, a voltage dividing means for dividing a voltage difference of such two kinds of voltage produced by the voltage producing means to produce the predetermined kind of voltage, and an amplifying means for current amplification of each voltage produced by the voltage dividing means.

In this invention, the voltage producing means produces two kinds of voltage and the voltage dividing means divides a voltage difference of two kinds of voltage to produce the predetermined kind of voltage. The amplifying means executes current amplification of each voltage produced by the voltage dividing means.

### BRIEF DESCRIPTION OF THE DRAWINGS

Other objects and advantages of the present invention will be apparent from the following detailed description of the presently preferred embodiments thereof, which description should be considered in conjunction with the accompanying drawings in which:

FIG. 1 is a block diagram showing a structure example of a driving voltage generator (of a liquid crystal display unit) as the first embodiment of the present invention;

FIG. 2 is a block diagram showing a structure example of a driving voltage generator (of a liquid crystal display unit) as the second embodiment of the present invention;

FIG. 3 is a diagram showing an example of voltages used for driving a liquid crystal display unit in ASDM; and

FIG. 4 is a block diagram showing a structure example of a driving voltage generator (of a liquid crystal display unit) of the related art.

### DESCRIPTION OF THE PREFERRED EMBODIMENTS

§1. First Embodiment

The first embodiment of the present invention will be explained with reference to the accompanying drawings.

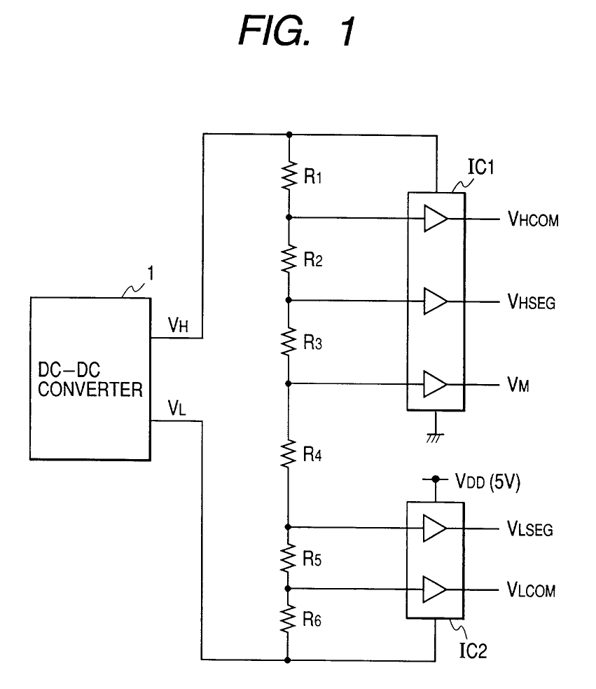

FIG. 1 is a block diagram showing a structure example of a driving voltage generator (of a liquid crystal display unit) as the first embodiment of the present invention.

In this figure, a DC-DC converter 1 is structured by a hybrid IC formed of a voltage boosting circuit composed of a switching IC and a transformer, etc.

The DC-DC converter 1 raises an input voltage (5 [V] as an example) to produce voltages VH and VL. Here, the voltage VH is ranged, as an example, from 30 to 40 [V], while the voltage VL from −25 to −35 [V].

However, there is a following relationship between the voltages VH and VL.

(VH+VL)/2 VM=2.5 [V]

Therefore, the reference voltage V M can be produced easily when producing the reference voltage VM by means of the resistance division.

The resistors R1 to R6 divide a voltage difference between the voltages VH and VL through resistance division.

Since each voltage is produced by resistance division, accuracy of the resistors R1 to R6 is set to +1% or higher.

Operational amplifiers IC1, IC2 output the voltages through current amplification of the resistance-divided voltages. Here, the operational amplifiers IC1, IC2 are respectively formed as different packages. The operational amplifier IC1 receives supply of the voltage VH and ground (GND) potential as the power source voltages.

Meanwhile, the operational amplifier IC2 receives supply of the voltages VDD and VL as the power source voltages. Here, the voltage VDD is 5 [V], as an example.

Namely, the power source voltages of 30 to 40 [V] are supplied to the operational amplifiers IC1 and IC2.

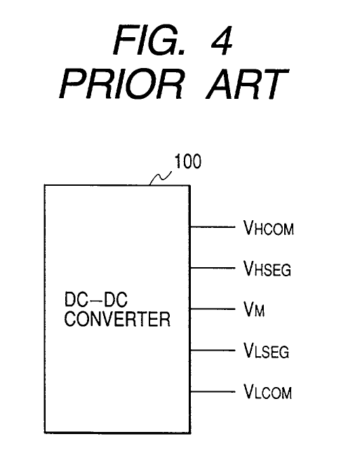

The apparatus shown in FIG. 1 has solved the problems of the related art apparatus shown in FIG. 4.

\hat{1} The DC-DC converter 1 requires only a couple of output terminals, resulting in reduction in size.

\hat{2} The DC-DC converter 1 requires only a couple of output terminals, resulting in reduction of manufacturing cost.

\hat{3} The resistors R1 to R6 are provided in the outside of the DC-DC converter 1 (hybrid IC). Therefore, the resistors R1 to R6 can be exchanged very easily. As a result, the voltages V HCOM, V HSEG, V M, V LSEG, V LCOM can be adjusted very easily.

§2. Second Embodiment

Next, the second embodiment of the present invention will be explained.

In the apparatus shown in FIG. 1, as explained previously, the power source voltages of 30 to 40 [V] are supplied to the operational amplifiers IC1 and IC2.

In this case, the maximum values of the output currents of the voltages V HCOM, V LCOM, V M are ranged from 10 to 15 [mA]. On the other hand, the maximum values of the output currents of the voltages V HSEG and V LSEG are ranged from 30 to 40 [mA].

Therefore, the apparatus shown in FIG. 1 has been accompanied by the problem that the operational amplifiers are heated up to the temperature of about 70 to 80° C. due to the current dissipated by the voltages V HSEG, V LSEG.

The driving voltage generator of this embodiment (namely, the second embodiment) has been proposed to solve the problem of heat generation.

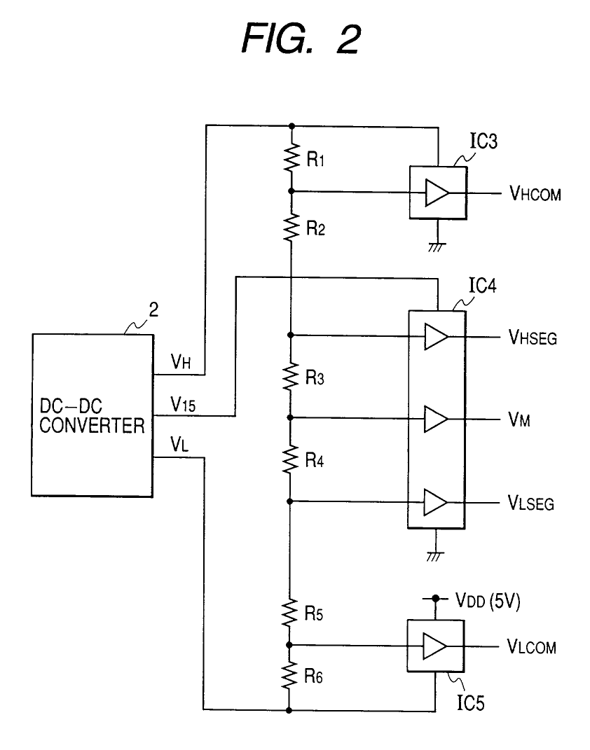

FIG. 2 is a block diagram showing a structure example of the driving voltage generator (of a liquid crystal display unit) by the second embodiment of the present invention.

In this figure, the DC-DC converter 2 raises an input voltage (5 [V], as an example) to newly produce an intermediate voltage V15, in addition to the voltages VH and VL.

Potentials of the voltages VH and VL are equal to those of the apparatus shown in FIG. 1. Meanwhile, the intermediate voltage V15 is ranged from 10 to 15 [V] as an example. Here, for the voltage value of intermediate voltage V15, higher accuracy is not required and a rough value may be assigned to this intermediate voltage.

Resistors R1 to R6 are similar to those in the apparatus shown in FIG. 1.

The operational amplifiers IC3 to IC5 provide outputs through current amplification of each voltage divided by resistors. Here, the operational amplifiers IC3 to IC5 are respectively provided in different packages and the operational amplifiers IC3 and IC5 are formed as the high dielectric resistance operational amplifiers. Meanwhile, the operational amplifier IC4 is not required to have higher dielectric resistance.

To the operational amplifier IC3, the voltage VH and the ground potential (GND) are supplied as the power source voltage. Namely, the power source voltage of 30 to 40 [V] is supplied to the operational amplifier IC3.

To the operational amplifier IC4, the intermediate voltage V15 and ground potential (GND) are supplied as the power source voltage. Namely, the power source voltage of 10 to 15 [V] is supplied to the operational amplifier IC4.

To the operational amplifier IC5, the voltages VDD and VL are supplied as the power source voltage. Here, the voltage VDD is 5 [V], as an example. Namely, the power source voltage ranged from 40 to 40 [V] is supplied to the operational amplifier IC5.

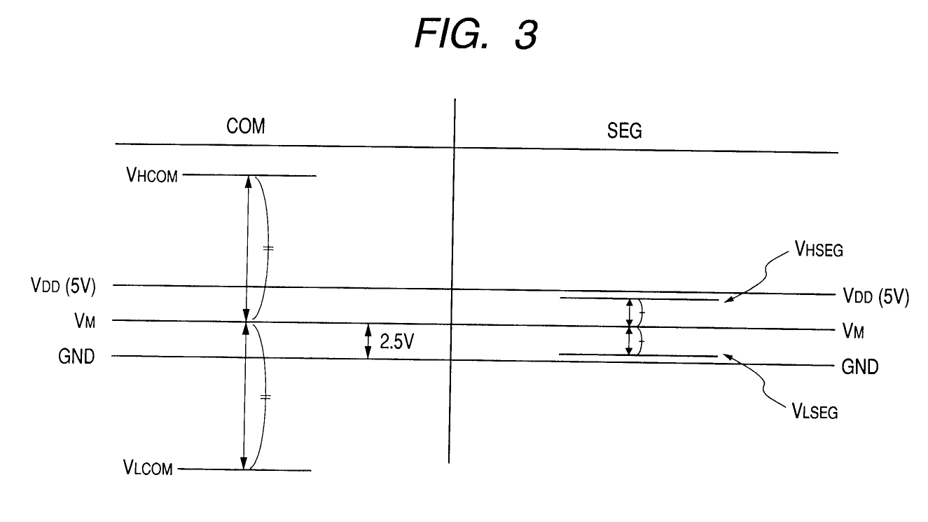

As shown in FIG. 3, in ASDM, the absolute values of voltages V HSEG and V LSEG are smaller than those of the voltages V HCOM and V LCOM.

Therefore, as shown in FIG. 2, the intermediate voltage V15 is newly added in this apparatus and this intermediate voltage V15 is supplied only to the operational amplifier (IC4) in the segment side as the power source voltage.

Thereby, the power source voltage of the operational amplifier IC4 can be reduced (to 10 to 15 [V]). As a result, heat generation in the operational amplifier IC4 can be reduced.

Moreover, since the intermediate voltage V15 has been newly added in the apparatus shown in FIG. 2, the power source voltage of the operational amplifier in the common side can be isolated from the power source voltage of the operational amplifier in the segment side.

Accordingly, the operational amplifier in the common side may be isolated from the operational amplifier in the segment side in unit of package.

As a result, the operational amplifiers of the specifications suitable for the voltage and current levels may be selected in both the common and segment sides.

The preferred embodiments of the present invention have been explained in detail with reference to the accompanying drawings, but the practical structure of the present invention is not limited thereto, allowing various modifications in design within the scope of the present invention.

As explained previously, according to the present invention, a small size and low price driving voltage generator of a liquid crystal display unit can be structured.

Moreover, the present invention also realizes easier adjustment of output voltages.

What is claimed is:

1. A driving voltage generator of a liquid crystal display unit, comprising:
a voltage producing means for producing two kinds of voltage;
a voltage dividing means for dividing a potential difference between said two kinds of voltage produced by said voltage producing means to produce the predetermined kinds of voltage; and
an amplifying means for current amplification of each voltage produced by said voltage dividing means.

2. The driving voltage generator of a liquid crystal display unit according to claim 1, wherein said voltage producing means is a hybrid IC and said voltage dividing means is provided in the outside of said hybrid IC.

3. The driving voltage generator of a liquid crystal display unit according to claim 1, wherein said predetermined kinds of voltage produced by said voltage dividing means are high level common voltage, high level segment voltage, reference voltage, low level segment voltage and low level common voltage used in ASDM.

4. The driving voltage generator of a liquid crystal display unit according to claim 3, wherein said amplifying means is composed of a high level amplifier for amplifying at least said high level common voltage and said high level segment voltage and a low level amplifier for amplifying at least said low level segment voltage and said low level common voltage, said high level amplifier receives as the power source voltage supply of the high level voltage which is one of said two kinds of voltage produced by said voltage producing means and said low level amplifier receives as the power source voltage supply of the low level voltage which is one of said two kinds of voltage produced by said voltage producing means.

5. The driving voltage generator of a liquid crystal display unit according to claim 3, wherein an arithmetic mean of said two kinds of voltage produced by said voltage producing means is equal to said reference voltage in said ASDM.

6. A driving voltage generator of a liquid crystal display unit comprising:
a voltage producing means for producing two kinds of voltage and an intermediate voltage having the intermediate potential between said two kinds of voltage;
a voltage dividing means for dividing a potential difference of said two kinds of voltage produced by said voltage producing means to produce the predetermined kinds of voltage; and
an amplifying means for voltage amplification of each voltage produced by said voltage dividing means.

7. The driving voltage generator of a liquid crystal display unit according to claim 6, wherein said voltage producing means is a hybrid IC and said voltage dividing means is provided in the outside of said hybrid IC.

8. The driving voltage generator of a liquid crystal display unit according to claim 6, wherein said predetermined kinds of voltage produced by said voltage dividing means include high level common voltage, high level segment voltage, reference voltage, low level segment voltage and low level common voltage in the ASDM.

9. The driving voltage generator of a liquid crystal display unit according to claim 8, wherein said amplifying means is composed of a high level amplifier for amplifying voltage of said high level common voltage, an intermediate level amplifier for amplifying the voltage of said high level segment voltage, said reference voltage and said low level segment voltage and low level amplifier for amplifying current of said low level common voltage and said high level amplifier receives as the power source voltage supply of the high level voltage which is one of said two kinds of voltages produced by said voltage producing means, said intermediate level amplifier receives supply of said intermediate voltage produced by said voltage producing means as the power source voltage and said low level amplifier receives as the power source voltage supply of low level voltage which is one of said two kinds of voltage produced by said voltage producing means.

10. A driving voltage generator of a liquid crystal display unit according to claim 9, wherein said high level amplifier, said intermediate level amplifier and said low level amplifier are respectively operation amplifiers.
